(19) United States
(12) Patent Application Publication
(10) Pub. No.: US 2003/0121258 A1
(43) Pub. Date: Jul. 3, 2003

(54) Hydraulic control system for reducing motor cavitation

(76) Inventor: Kazunori Yoshino, Kobe (JP)

Correspondence Address: Finnegan, Henderson, Farabow,, Garrett & Dunner, L.L.P., 1300 I Street, N.W., Washington, DC, 20005-3315, US

(21) Appl. No.: 10/029,290

(22) Filed: Dec. 28, 2001

(51) Int. Cl. F16D 31/02

(52) U.S. Cl. 60/459

(57) ABSTRACT

A fluid control system includes at least one double-acting cylinder and at least one fluid-driven motor. A pressurized fluid source supplies pressurized fluid flow to the at least one double-acting cylinder and the at least one fluid-driven motor, and a tank receives return fluid flow from the at least one double-acting cylinder and the at least one fluid-driven motor. A back pressure element is disposed between the tank and the motor and may influence a fluid backpressure condition of fluid discharged from the motor. A dedicated flow line may provide make-up fluid to the motor at a location between the motor and the back pressure element.

### TECHNICAL FIELD

The invention relates generally to a fluid control system and, more particularly, to a hydraulic control system with reduced cavitation effects

### BACKGROUND

Conventional hydraulic systems typically include one or more hydraulic cylinders and/or hydraulic motors for operating work implements, for example, buckets, shovels, and handlers. In such systems, cavitation may be generated in a hydraulic motor when the supply fluid flow to the motor is less than the return fluid flow from the motor. Motor cavitation can damage the hydraulic system and, in particular, the motor. In addition, motor cavitation may cause an unpleasant noise as the motor is stopped.

One mechanism for reducing motor cavitation involves joining the fluid-return lines of all hydraulic cylinders and hydraulic motors in a hydraulic system to form a main return line. A back pressure check valve is installed at the main return line downstream of where the fluid return lines are joined. The pressurized fluid upstream of the back pressure check valve provides a make-up function to the return flow sides of the cylinders and motors. Although a high back pressure setting is necessary to prevent motor cavitation, such a high setting is not necessary to prevent cavitation by the hydraulic cylinders. In addition, when retracting a plurality of cylinders, the return flow increases. Thus, an unnecessary and excessive amount of back pressure occurs at the return line, and pressurized fluid flows across the back pressure check valve, resulting in an undesirable energy loss.

Another typical mechanism for reducing motor cavitation, as shown in U.S. Pat. No. 5,673,605, includes providing a hydraulic system with a back pressure check valve at a return flow line of a hydraulic motor and allowing return fluid from the other motors and hydraulic cylinders to return directly to the tank. Also, a flow line is added upstream of the back pressure check valve to feed the return fluid of the motor back to the motor. However, in this situation, a sufficient make-up flow may not be achieved due, for example, to drain leakage of pressurized oil as a result of the high pressure generated at the motor return port when stopping rotation of the motor. Consequently, make-up flow becomes short and motor cavitation may occur.

A fluid control system for effectively and efficiently providing make-up fluid flow to a hydraulic motor to reduce motor cavitation is desired. The present invention is directed to provide such a system while solving one or more of the problems set forth above.

### SUMMARY OF THE INVENTION

According to one aspect of the invention, a fluid control system may include at least one double-acting cylinder and at least one fluid-driven motor. A pressurized fluid source may supply pressurized fluid flow to the at least one double-acting cylinder and the at least one fluid-driven motor, and a tank may receive return fluid flow from the at least one double-acting cylinder and the at least one fluid-driven motor. A back pressure element may be disposed between the tank and the motor. The back pressure element may be configured to influence a back pressure condition of fluid discharged from the motor. A dedicated flow line may be configured to provide make-up fluid to the motor at a location between the motor and the back pressure element.

According to another aspect of the invention, a method for controlling a hydraulic circuit may include supplying fluid to at least one motor and to at least one cylinder from a pressurized supply. The method may also include directing fluid away from the at least one cylinder and into a tank, and directing fluid away from the at least one motor, across a back pressure element, and into a tank. The method may further include supplying a dedicated make-up fluid supply to a valve arrangement at a location between the at least one motor and the back pressure element.

It is to be understood that both the foregoing general description and the following detailed description are exemplary and explanatory only and are not restrictive of the invention, as claimed.

### BRIEF DESCRIPTION OF THE DRAWINGS

The accompanying drawing, which is incorporated in and constitutes a part of this specification, illustrates an exemplary embodiment of the invention and, together with the description, serves to explain the principles of the invention. In the drawing,

FIG. 1 is a schematic illustration of a hydraulic circuit in accordance with one embodiment of the present invention.

### DETAILED DESCRIPTION

Reference will now be made in detail to embodiments of the invention, an example of which is illustrated in the accompanying drawings.

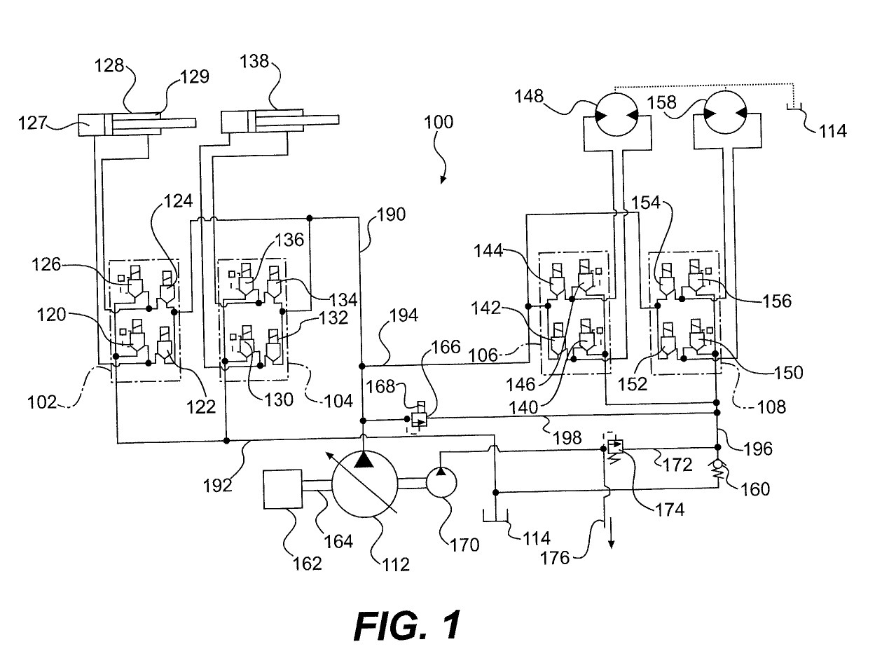

In accordance with the present invention, a fluid control system is provided. Referring to FIG. 1, a fluid control system, for example, hydraulic circuit 100, may include a plurality of flow control valve arrangements such as independent metering valve arrangements 102, 104, 106, 108. As shown in FIG. 1, the hydraulic circuit 100 may include a pressurized fluid source, for example, a pump 112. The circuit 100 may also include a tank 114. The pump 112 may comprise, for example, a variable output, high pressure pump or a constant output, high pressure pump. The hydraulic circuit 100 may further include an engine 162 or other motive force for providing a drive force to power the pump 112. The drive force may be provided, for example, by way of a drive shaft 164 or other known mechanical linkage.

Each independent metering valve arrangement 102, 104, 106, 108 may include a plurality of independently-operated, electronically-controlled metering valves. For example, independent metering valve arrangement 102 may include a plurality of metering valves 120, 122, 124, 126. The metering valves 120, 122, 124, 126 control fluid flow between a double acting cylinder, for example, hydraulic cylinder 128, the pump 112, and the tank 114. The metering valves may be spool valves, poppet valves, or any other conventional type of metering valve that would be appropriate. The hydraulic cylinder 128 includes a head end 127 and a rod end 129. Thus, the metering valves may be referred to individually as a cylinder-to-tank head end (CTHE) metering valve 120, a pump-to-cylinder head end (PCHE) metering valve 122, a pump-to-cylinder rod end (PCRE) metering valve 124, and a cylinder-to-tank rod end (CTRE) metering valve 126.

Similarly, independent metering valve arrangement 104 may include a CTHE metering valve 130, a PCHE metering valve 132, a PCRE metering valve 134, and a CTRE metering valve 136 for controlling fluid flow between a hydraulic cylinder 138, the pump 112, and the tank 114.

The pump-to-cylinder metering valves 122, 124, 132, 134, often referred to generally as meter-in valves, are fed in parallel with pressurized fluid from the pump via cylinder supply line 190. The cylinder-to-tank metering valves 120, 126, 130, 136, often referred to generally as meter-out valves, allow pressurized fluid to exit from the respective cylinder 128, 138 to the tank 114 via cylinder return line 192.

Independent metering valve arrangement 106 may include metering valves 140, 142, 144, 146. In independent metering valve arrangement 106, the metering valves 140, 142, 144, 146 control fluid flow between a fluid motor, for example, reversible hydraulic motor 148, the pump 112, and the tank 114. Since the reversible hydraulic motor 148 does not have a head end and a rod end, the cylinder-to-tank metering valves 140, 146 may be referred to generally as meter-out valves and the pump-to-cylinder metering valves 142, 144 may be referred to generally as meter-in valves.

Similarly, independent metering valve arrangement 108 may include cylinder-to-tank metering, or meter-out, valves 150, 156 and pump-to-cylinder metering, or meter-in, valves 152, 154 for controlling fluid flow between a reversible hydraulic motor 158, the pump 112, and the tank 114.

Pressurized fluid may be fed from the pump 112 to the meter-in valves 142, 144, 152, 154 via motor supply line 194. The meter-in valves 142, 144, 152, 154 are fed parallel with one another and parallel with the pump-to-cylinder metering valves 122, 124, 132, 134. The meter-out valves 140, 146, 150, 156 allow pressurized fluid to exit from the respective motor 148, 158 to the tank 114 via motor return line 196. In addition, the hydraulic motors 148, 158 are in communication with the tank 114 via drain flow line 197 so that any fluid leakage during stoppage of the motors 148, 158 may be drained.

A back pressure element, for example, a back pressure check valve 160, may be disposed on the motor return line 196 between the meter-out valves 140, 146, 150, 156 and the tank 114. The back pressure check valve 160 acts to create a supply of pressurized fluid upstream of the check valve 160. The supply of fluid may be pressurized at or above the pressure setting of the check valve 160.

The hydraulic circuit 100 may also include a combination main relief and bypass valve 166. The combination valve 166 may include an electronically-operated solenoid 168. The combination valve 166 may be configured such that when the solenoid 168 is energized with predetermined current, the valve 166 functions as a main relief valve, and when the solenoid 168 is energized with current varying gradually from zero, the valve 166 functions as a bypass valve.

In one embodiment, pressurized fluid flowing across the combination valve 166 may be brought in communication with the motor return line 196 at a location upstream of the back pressure check valve 160 via by-pass and relief return line 198. Thus, the pressurized fluid supplied via by-pass and relief return line 198 may contribute to the pressurized fluid in the motor return line 196 upstream of the check valve 160. Alternatively, the pressurized fluid flowing across the combination valve 166 may be emptied directly to the tank 114 via direct return line (not shown).

The hydraulic circuit 100 may further include a pilot pump 170. The pilot pump 170 provides pressurized fluid to the circuit 100 to perform work other than powering the hydraulic cylinders 128. 138 and motors 148, 158, such as controlling movement of valves and the like in a well known manner. For example, the pilot pump 170 may supply pressurized fluid used to shift valves between multiple positions.

A pilot flow line 172 may supply pressurized fluid from the pilot pump 170 to the motor return line 196 at a location upstream of the back pressure check valve. Thus, the pressurized fluid supplied via pilot flow line 172 may contribute to the pressurized fluid in the motor return line 196 upstream of the check valve 160. Alternatively, the pilot flow line 172 providing fluid communication with the motor return line 196 may be eliminated.

A pilot relief valve 174 may be disposed at the pilot flow line 172. Thus, the pressurized fluid supplied by the pilot pump 170 may flow across the pilot relief valve 174 and to the motor return line 196 when the relief valve 174 is opened. Otherwise, the pilot pump 170 may supply pressurized fluid to any pilot-operated elements of the hydraulic circuit 100, for example, valves shifted by pressurized fluid from the pilot pump 170.

As shown in FIG. 1, the hydraulic circuit 100 may include the bypass and relief return line 198 from the combination main relief and bypass valve 166 and the pilot flow line 172 from the pilot pump 170 both communicating with the motor return line 196 at a location upstream of the back pressure check valve 160. Alternatively, the circuit 100 may include one of the by-pass and relief return line 198 from the combination main relief and bypass valve 166 and the pilot flow line 172 from the pilot pump 170 in communication with the motor return line 196 at a location upstream of the back pressure check valve 160.

### INDUSTRIAL APPLICABILITY

In use, the metering valves 120, 126, 130, 136 control cylinder-to-tank fluid flow while the metering valves 122, 124, 132, 134 control pump-to-cylinder fluid flow. Conventional extension of the hydraulic cylinders 128, 138 is achieved by selective, operator-controlled actuation of the metering valves 122, 126, 132, 136, and retraction is achieved by simultaneous operator controlled actuation of the metering valves 120, 124, 130, 134.

Similarly, metering valves 140, 146, 150, 156 control motor-to-tank fluid flow while metering valves 142, 144, 152, 154 control pump-to-motor fluid flow. Conventional operation of the bi-directional motors 148, 158 is achieved by selective, operator-controlled actuation of the metering valves 142, 146, 152, 156 for a first direction and the metering valves 140, 144, 150, 154 for a second direction.

Referring to FIG. 1, the cylinder return line 192 may be connected directly to the tank 114. Thus, pressurized fluid being returned from the hydraulic cylinders 128, 138 will not pass through the back pressure check valve 160. As a result, energy loss will not occur even though a significant amount of fluid flow from the cylinder return line 192 may be generated when retracting the cylinders 128, 138.

When at least one of the hydraulic motors 148, 158 is rotating, either motor 148, 158 may be stopped, for example, by returning an operational lever to a neutral position. When stopping the motors 148, 158, the appropriate, associated meter-in valves 142, 144, 152, 154 are closed, shutting off the supply of pressurized fluid to the motors 148, 158. Due to their momentum, the motors 148, 158 do not stop instantaneously. Thus, some amount of fluid continues to be returned to the appropriate, associated meter-out valves 140, 146, 150, 156 even after the meter-in valves 142, 144, 152, 154 are closed. In addition, some amount of pressurized fluid may leak from the motors 148, 158 and return to the tank 114 via drain flow line 197.

To provide a make-up fluid flow to the appropriate meter-out valves 140, 146, 150, 156 which is able to allow reverse flow from motor return line 196 to respective motor circuit to avoid motor cavitation, the back pressure check valve 160 is disposed at the motor return line 196. In addition, pressurized fluid flow passing through the combination main relief and by-pass valve 166 and/or pressurized fluid from the pilot flow line 172 are joined to the motor return line 196 at a location upstream of the back pressure check valve 160. Thus, when at least one of the hydraulic motors 148, 158 is stopped, for example, by placing an operational lever at a neutral position, a proper back pressure will occur upstream of the back pressure check valve 160.

When the hydraulic cylinders 128, 138 are in a standby mode, for example, by placing an operational lever at a neutral position, the combination main relief and by-pass valve 166 may be opened. As a result, pressurized fluid passing through the combination valve 166 provides fluid flow to the motor return line 196 at a location upstream of the back pressure check valve 160. The fluid flow passing through the combination valve 166 may generate the necessary back pressure upstream of the back pressure check valve 160 to provide make-up flow to the motors 148, 158, thus reducing motor cavitation and its associated noise. An upstream back pressure greater than atmospheric pressure provides a quicker and more complete make-up function, for example, by causing a make-up spool to lift and allow the flow of make-up fluid.

In a hydraulic control system including pressurized fluid flow passing through the combination main relief and by-pass valve 166 and pressurized fluid from the pilot flow line 172, both joined to the motor return line 196 at a location upstream of the back pressure check valve 160, the fluid from the pilot flow line 172 may generate or contribute to the generation of the necessary back pressure upstream of the back pressure check valve 160 that provides make-up flow to the motors 148, 158. In a hydraulic control system where the motor return line 196 does not receive pressurized fluid flow passing through the combination main relief and by-pass valve 166, the fluid from the pilot flow line 172 may generate the necessary back pressure upstream of the back pressure check valve 160 that provides make-up flow to the motors 148, 158.

Referring again to FIG. 1, when one or more of the hydraulic cylinders 128, 138 is being operated and at least one of the motors 148, 158 is stopped, for example, by returning an operation lever to a neutral position, the combination main relief and by-pass valve 166 may be closed. Therefore, a significant fluid flow across the combination valve 166 cannot be expected. However, pressurized fluid from the pilot flow line 172, which is joined to the motor return line 196 at a location upstream of the back pressure check valve 160, may generate the necessary back pressure upstream of the back pressure check valve 160 that provides make-up flow to the motors 148, 158. Thus, motor cavitation and its associated noise may be reduced.

It should be appreciated that the hydraulic circuit 100 may include any number of hydraulic cylinders 128, 138 and/or any number of hydraulic motors 148, 158 and/or other additional hydraulically-operated actuators. Also, it should be appreciated that the circuit 100 may include more than one pump 112. If more than one pump 112 is provided, the circuit 100 may include more than one combination main relief and by-pass valve 166 and/or one or more flow combiners, as is readily known in the art.

Thus, the present invention may provide a hydraulic control system that may minimize motor cavitation when stopping a motor. Since return flow from a motor is nearly equal to an inlet supply flow from a pump to the motor, only a relatively small amount of additional fluid is needed to provide a make-up function to the motor when the motor is stopped to supplement the amount of drain flow from the motor. This amount of additional fluid will not reach the magnitude of return flow from a cylinder head end when retracting the cylinder. A back pressure check valve disposed at the motor return line and pressurized fluid provided from at least one of a by-pass and relief return line and a pilot flow line generate sufficient back pressure to provide a make-up fluid flow to a motor and reduce motor cavitation. Separation of the cylinder return line from the motor return line and connection of the cylinder return line to the tank avoids a large power loss that would otherwise occur at the back pressure check valve. Therefore, when properly implemented, the hydraulic control system of the present invention may minimize cavitation in an effective and efficient manner and without undesirable energy loss.

It will be apparent to those skilled in the art that various modifications and variations can be made in the hydraulic control system without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A fluid control system comprising:
at least one double-acting cylinder;
at least one fluid-driven motor;
a pressurized fluid source configured to supply pressurized fluid flow to the at least one double-acting cylinder and the at least one fluid-driven motor;
a tank configured to receive return fluid flow from the at least one double-acting cylinder and the at least one fluid-driven motor;
a back pressure element disposed between the tank and the motor, the back pressure element being configured to influence a fluid backpressure condition on fluid discharged from the motor; and
a dedicated flow line configured to provide make-up fluid to the motor at a location between the motor and the back pressure element.

2. The system of claim 1, further including a combination main-relief and by-pass valve, the pressurized fluid source being configured to provide fluid across the combination main relief and by-pass valve and to the dedicated flow line.

3. The system of claim 1, further including a pilot pump and a pilot relief valve, the pilot pump being configured to provide fluid across the pilot relief valve and to the dedicated flow line.

4. The system of claim 3, further including a motor return line configured to provide fluid communication between the at least one fluid-driven motor and the tank, the back pressure element being associated with the motor return line, and the dedicated flow line being configured to provide makeup fluid to the motor return line upstream of the back pressure element.

5. The system of claim 4, further including a cylinder return line configured to provide fluid communication between the at least one double-acting cylinder and the tank without passing across the back pressure element.

6. The system of claim 5, further including:
a combination main-relief and by-pass valve;
a pilot pump;
a pilot relief valve; and
a second dedicated flow line configured to provide make-up fluid to the at least one fluid-driven motor at a location between the motor and the back pressure element,
wherein the pressurized fluid source is configured to provide fluid across the combination main-relief and by-pass valve and to the dedicated flow line, and wherein the pilot pump is configured to provide fluid across the pilot relief valve and to the second dedicated flow line, the motor return line being configured to receive fluid from at least one of the dedicated flow line and the second dedicated flow line.

7. The system of claim 5, further including:
a plurality of double-acting cylinders; and
a plurality of fluid-driven motors, the cylinder return line being configured to provide fluid communication from the plurality of double-acting cylinders to the tank and the motor return line being configured to provide fluid communication from the plurality of fluid-driven motors to the tank.

8. The system of claim 7, further including:
a combination main-relief and by-pass valve;
a pilot pump;
a pilot relief valve; and
a second dedicated flow line configured to provide make-up fluid to the plurality of fluid-driven motors at a location between the motors and the back pressure element,
wherein the pressurized fluid source is configured to provide fluid across the combination main-relief and by-pass valve and to the dedicated flow line, and wherein the pilot pump is configured to provide fluid across the pilot relief valve and to the second dedicated flow line, the motor return line being configured to receive fluid from at least one of the dedicated flow line and the second dedicated flow line.

9. The system of claim 7, wherein at least one of the double-acting cylinders includes a hydraulic cylinder and at least one of the fluid-driven motors includes a reversible, hydraulic motor.

10. The system of claim 7, further including:
a plurality of flow control valve arrangements, each of the plurality of flow control valve arrangements being associated with and being configured to control pressurized fluid flow to one of the plurality of double-acting cylinders.

11. The system of claim 10, further including:
a combination main-relief and by-pass valve;
a pilot pump;
a pilot relief valve; and
a second dedicated flow line configured to provide make-up fluid to the plurality of fluid-driven motors at a location between the motors and the back pressure element,
wherein the pressurized fluid source is configured to provide fluid across the combination main-relief and by-pass valve and to the dedicated flow line, and wherein the pilot pump is configured to provide fluid across the pilot relief valve and to the second dedicated flow line, the motor return line being configured to receive fluid from at least one of the dedicated flow line and the second dedicated flow line.

12. The system of claim 10, wherein each of the plurality of flow control valve arrangements includes four metering valves.

13. The system of claim 12, wherein the four metering valves include a pair of meter-in valves and a pair of meter-out valves.

14. The system of claim 10, wherein at least one of the plurality of flow control valve arrangements includes an independent metering valve.

15. A method for controlling a hydraulic circuit, comprising:
supplying fluid to at least one motor and to at least one cylinder from a pressurized supply;
directing fluid away from the at least one cylinder and into a tank;
directing fluid away from the at least one motor, across a back pressure element, and into a tank; and
supplying a dedicated make-up fluid supply to a valve arrangement at a location between the at least one motor and the back pressure element.

16. The method of claim 15, wherein said supplying includes directing fluid from the pressurized supply to the valve arrangement to introduce make-up fluid to the at least one motor.

17. The method of claim 16, wherein said directing fluid from the pressurized supply includes directing fluid across a combination main relief and by-pass valve.

18. The method of claim 15, wherein said supplying includes directing fluid from a pilot fluid supply to the valve arrangement to introduce make-up fluid to the at least one motor.

19. The method of claim 18, wherein said directing a pilot fluid supply includes directing fluid across a pilot relief valve.

20. The method of claim 15, wherein said supplying includes directing fluid from at least one of the pressurized supply and a pilot fluid supply to the valve arrangement to introduce make-up fluid to the at least one motor.

21. The method of claim 15, wherein said directing fluid away from the at least one cylinder includes directing fluid into the tank without passing across the back pressure element.
